(19) United States
(12) Patent Application Publication
(10) Pub. No.: US 2019/0014761 A1
(43) Pub. Date: Jan. 17, 2019

(54) FISHING LURE

(71) Applicants: Raymond A. Rosher, Miami, FL (US); Marvin J. Marshall, JR., Palm Bay, FL (US); Matthew J. Neber, Miami Beach, FL (US)

(72) Inventors: Raymond A. Rosher, Miami, FL (US); Marvin J. Marshall, JR., Palm Bay, FL (US); Matthew J. Neber, Miami Beach, FL (US)

(21) Appl. No.: 16/037,010

(22) Filed: Jul. 17, 2018

Related U.S. Application Data
(60) Provisional application No. 62/642,162, filed on Mar. 13, 2018.
(60) Provisional application No. 62/533,512, filed on Jul. 17, 2017.

(51) Int. Cl. A01K 85/18

(52) U.S. Cl. CPC A01K 85/18

(57) ABSTRACT

A fishing lure. The fishing lure includes a channel running therethrough having an entrance opening and an exit opening. A fishing line is run through the fishing lure such that the fishing line enters through the entrance opening, runs through the channel, and exits out of the exit opening of the fishing lure. The fishing hook is then knotted to an end of the fishing line disposed beyond the exit opening.

### CROSS-REFERENCE TO RELATED APPLICATION

This application claims the benefit of priority of U.S. provisional application No. 62/533,512, filed Jul. 17, 2017, and U.S. provisional application No. 62/642,162, filed Mar. 13, 2018, the contents of which are herein incorporated by reference.

### BACKGROUND OF THE INVENTION

The present invention relates to fishing lures and, more particularly, to an interchangeable fishing lure that displaces the weight of the lure while catching a fish.

A fishing lure is a type of artificial fishing bait which is designed to attract a fish's attention. The lure uses movement, vibration, flash. and color to bait fish. Many lures are equipped with one or more hooks that are used to catch fish when they strike the lure. The fishing line is connected directly to the fishing lure body and not directly to the fish hook. Often the centrifugal forces created on the fishing lure, as a fish shakes its head, causes the fish hook to pull free from the fish. This is due to the weight of the fishing lure being forcefully slung back and forth as the fish hook is attached to and is an integral part of it. In addition, the skirt and dressing are permanently attached to the fishing lure head. If the user wants to change the color of the lure, they must change the entire fishing lure. As can be seen, there is a need for an interchangeable fishing lure that displaces the weight of the lure while catching a fish.

### SUMMARY OF THE INVENTION

In one aspect of the present invention, a fishing lure comprises: a head comprising a first channel formed therethrough; and a sleeve comprising a second channel formed therethrough, wherein the head slidably engages with the sleeve to releasably attach the head to the sleeve, and the first channel of the head aligns with the second channel of the sleeve.

In another aspect of the present invention, a method of attaching a fishing hook and a fishing line to a fishing lure comprises steps of: providing the fishing lure, wherein the fishing lure comprises a channel running therethrough comprising an entrance opening and an exit opening; running the fishing line into the entrance opening, through the channel, and out of the exit opening of the fishing lure; and knotting the fishing hook to an end of the fishing line disposed beyond the exit opening.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a side elevation view of an embodiment of the present invention;

FIG. 3 is a cross-sectional view taken along line 3-3 of FIG. 1;

FIG. 3A is an exploded cross-sectional view of FIG. 3;

FIG. 4 is a cross sectional view of an embodiment of the present invention; and

FIG. 4A is an exploded cross-sectional view of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fishing lure. The present invention is designed so that a fishing line passes freely through the fishing lure and connects directly to the fish hook. As the centrifugal forces are created by the fish during battle, the skirt or dressing and the fish hook are designed to detach from the fishing lure head. This action dramatically reduces the centrifugal forces imparted on the fish hook, because of the freedom of movement of the fishing lures head. The present invention increases the likelihood of catching the fish, as the fish is less likely to throw the fish hook.

Further, the present invention is designed so the skirt or dressing can be interchanged quickly and easily. This is possible due to the slipper component design which incorporates keepers for attaching the skirt or dressing, and not directly to the fishing lure head. The slipper component is held on to the fishing lure head using keepers, which are designed to release upon sufficient force. In addition, the slipper component and the fishing lure head may incorporate four positions offset by 45 degrees upon which the hook point may be aligned to the fishing lure head for optimal performance.

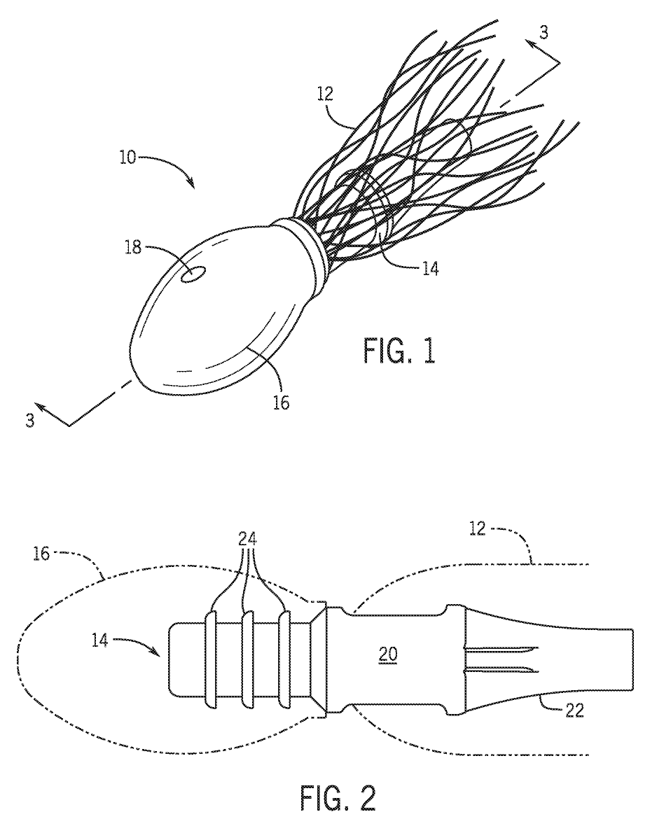

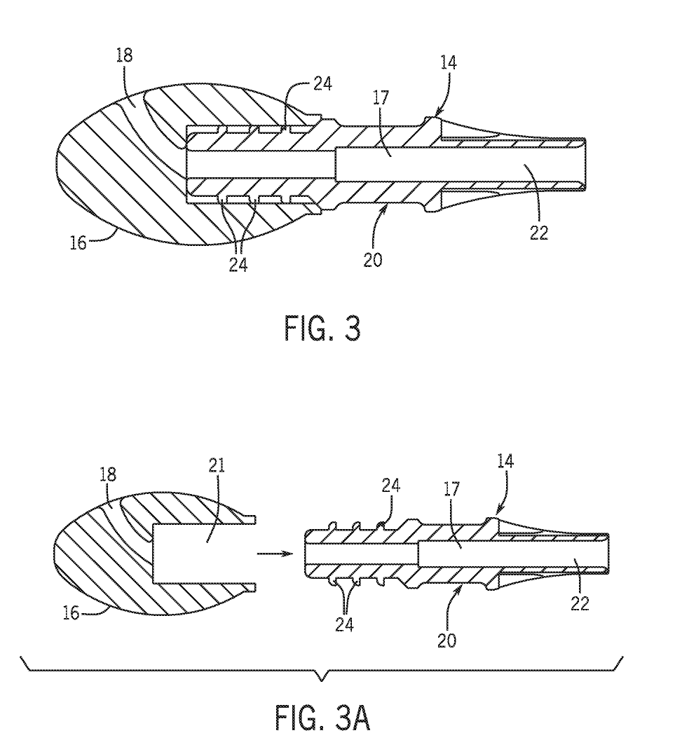

Referring to FIGS. 1 through 3A, the present invention includes a fishing lure 10. The fishing lure 10 includes a channel 17, 18 running therethrough having an entrance opening and an exit opening. A fishing line is run through the fishing lure 10 such that the fishing line enters through the entrance opening, runs through the channel, and exits out of the exit opening of the fishing lure 10. The fishing hook is then knotted to an end of the fishing line disposed beyond the exit opening. When a fish is caught by the fishing hook, the fishing hook and the fishing lure 10 separate, providing a better chance that the fish does not escape the hook.

The fishing lure 10 includes a head 16 and a sleeve 14 (slipper component). The head 16 includes a first channel 18 formed therethrough and the sleeve 14 includes a second channel 17 formed therethrough. The head 16 slidably engages with the sleeve 14 to releasably attach the head 16 and the sleeve 14 together. The first channel 18 of the head 16 aligns with the second channel 17 of the sleeve 14 forming the contiguous channel 17, 18 that runs through the fishing lure 10. The second channel 17 may further include a hook keeper 22 in which an end of the hook is disposed when casting the lure 10. When the fish is caught on an end of the fishing hook, the head 16 may detach from the sleeve 14 and the fishing hook.

In certain embodiments, the head 16 includes a bulbous shape and the sleeve 14 includes a tube shape. The head 16 may further include a slot 21 having an inner surface defining a shape to comport with an end of the sleeve 14. The slot 21 is contiguous with the first channel 18. The end of the sleeve 14 may further include a plurality of ribs 24 radially extending therefrom. In such embodiments, the end of the sleeve 14 slidably engages within the slot 21, releasably securing the head 16 to the sleeve 14.

In certain embodiments, a skirt 12 attaches to the sleeve 14 of the fishing lure 10 at a skirt area 20. The skirt 12 may be connected to the sleeve 14 by flexible adhesives, or other attachment materials, such as, but not limited to, wire, metal, plastic, rubber bands, twine or other synthetic materials. The entire fishing lure 10 with the skirt 12 may move along the fishing line independently once the centrifugal force is imparted on the fishing lure 10 by the fish.

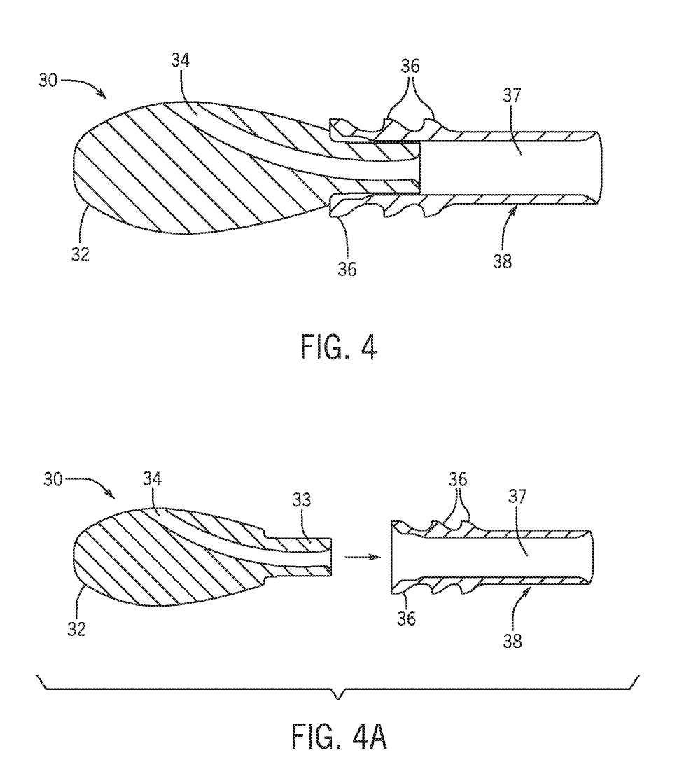

Referring to FIGS. 4A and 4B, the present invention includes a fishing lure 30 with a head 32 and a sleeve 38 (slipper component). The head 32 includes a first channel 34 formed therethrough and the sleeve 38 includes a second channel 37 formed therethrough. The head 32 slidably engages with the sleeve 37 to releasably attach the head 32 and the sleeve 38 together. For example, the head 32 includes an insert 33 protruding therefrom. The first channel 34 runs through the insert 33 and the insert 33 slidably engages within the second channel 37 of the sleeve 38. The first channel 34 of the head 32 aligns with the second channel 37 of the sleeve 38 forming a contiguous channel 34, 37 that runs through the fishing lure 30. When the fish is caught on an end of the fishing hook, the head 32 may detach from the sleeve 38 and the fishing hook.

A method of attaching a fishing hook and a fishing line to a fishing lure includes the steps of: providing the fishing lure, wherein the fishing lure comprises a channel running therethrough comprising an entrance opening and an exit opening; running the fishing line into the entrance opening, through the channel, and out of the exit opening of the fishing lure; and knotting the fishing hook to an end of the fishing line disposed beyond the exit opening.

The present invention may be symmetrical in design and can be used by both right and/or left-handed people. The present invention is designed to solve the problem of thrown or pulled hooks during battle with a fish. This problem is caused by the centrifugal forces created on the fishing lure which incorporates a permanently attached/embedded fish hook. When a fish shakes its head the weight of the fishing lure is slung back and forth, which often causes the fish hook to pull free. The present invention is designed so that the weight of the fishing lure detaches from the keeper components, so both units may slide away from the fish hook. The objective is to get the weight of the fishing lure away from the fish hook.

The components of the present invention can be made using several techniques, including but not limited to, plastic injection, blow or centrifugal molding, metal injection molding, or metal pour molding, 3D printing, CNC machining, metal or polymer forming, or stamping of various plastics or metals. The components could also be made of forged metals or sintering of various materials. The present invention could also be epoxied, glued, ultrasonically bonded or welded.

It should be understood, of course, that the foregoing relates to exemplary embodiments of the invention and that modifications may be made without departing from the spirit and scope of the invention as set forth in the following claims.

What is claimed is:

1. A fishing lure comprising:
a head comprising a first channel formed therethrough; and
a sleeve comprising a second channel formed therethrough, wherein
the head slidably engages with the sleeve to releasably attach the head to the sleeve, and
the first channel of the head aligns with the second channel of the sleeve.

2. The fishing lure of claim 1, wherein the head comprises a bulbous shape and the sleeve comprises a tube shape.

3. The fishing lure of claim 1, wherein the head further comprises a slot contiguous with the first channel, wherein an end of the sleeve slidably engages within the slot.

4. The fishing lure of claim 3, wherein the end of the sleeve further comprises a plurality of ribs radially extending therefrom.

5. The fishing lure of claim 1, wherein the head further comprises an insert protruding therefrom, wherein the first channel runs through the insert and the insert slidably engages within the second channel.

6. The fishing lure of claim 1, further comprising a skirting coupled to the sleeve.

7. A method of attaching a fishing hook and a fishing line to a fishing lure comprising steps of:
providing the fishing lure, wherein the fishing lure comprises a channel running therethrough comprising an entrance opening and an exit opening;
running the fishing line into the entrance opening, through the channel, and out of the exit opening of the fishing lure; and
knotting the fishing hook to an end of the fishing line disposed beyond the exit opening.

8. The method of claim 7, wherein the fishing lure comprises:
a head comprising a first channel formed therethrough; and
a sleeve comprising a second channel formed therethrough, wherein
the head slidably engages with the sleeve to releasably attach the head to the sleeve, and
the first channel of the head aligns with the second channel of the sleeve to form the channel.

9. The method of claim 8, wherein the head further comprises a slot contiguous with the first channel, wherein an end of the sleeve slidably engages within the slot.

10. The method of claim 8 wherein the head further comprises an insert protruding therefrom, wherein the first channel runs through the insert and the insert slidably engages within the second channel.
